(19) United States
(12) Patent Application Publication
(10) Pub. No.: US 2006/0105811 A1
(43) Pub. Date: May 18, 2006

(54) Mobile communicator

(75) Inventor: Chun-Jen Chen, Taipei (TW)

Correspondence Address: LADAS & PARRY, 26 WEST 61ST STREET, NEW YORK, NY, 10023, US

(73) Assignee: BENQ CORPORATION

(21) Appl. No.: 11/266,574

(22) Filed: Nov. 3, 2005

(30) Foreign Application Priority Data
Nov. 16, 2004 (TW) 93135096

(51) Int. Cl. H04B 1/38

(52) U.S. Cl. 455/558

(57) ABSTRACT

A mobile communication apparatus enable its' user to set limit on communication expense is disclosed herein. The mobile communication apparatus uses a communication module to perform wireless communication under the control of a limitation module which shuts off the communication module responding to a result from the comparison module showing that the cumulated expense is no less than the preset amount, which is input and stored in the storage module input by the subscriber or user. Because the above is real-time, thus the limitation module can automatically and immediately shut off the communication module when the cumulated expense reaches the preset amount, thus the limitation module efficiently prevents the communication expense from exceeding a preset amount.

### BACKGROUND OF THE INVENTION

(1) Field of the Invention

The invention relates to a mobile communication apparatus, and more particularly to a mobile communication apparatus capable of automatically limiting some dialing functions of the mobile communication apparatus when the communication expense of the mobile communication apparatus reaches a preset money amount.

(2) Description of the Prior Art

Similar to mobile communication apparatus such as cellular phone which brings ultimate convenience in communication between people in daily lives. In order to have this convenient service appears continuously in our daily lives, mobile service carriers are in a major role to calculate out the cost of each call according to calling times and calculating systems. The mobile service carriers will gather money to keep the service depending on the cost of different communication service types.

Customer will not know the amount of money due each month until they receive the bill after billing cycle. After the last billing cycle, if the customer overused the mobile service, they will usually be in a upset mood after they receive the bill from the service provider. Although they still have pay the payment before the due date. In a long run, customer will contribute a lot of unnecessary amount to the mobile service.

Currently, calculation for mobile service fee is performed within the telecommunication service provider, and is based on CAI (Charge Advice Information) in the cost of the usage on the communication device. Wherein the calculation for mobile communication service fee is based on a fee-related data which includes the communication rates, service types, deductibles, communication durations, communication categories, and communication areas. The communication categories include communication in the same carriers, communication between different carriers, and text message communication.

Nowadays, calculations of user's bills are by service operates' own billing systems which is not provided bills to customers in real time. In order to know the total amount on all calls during the billing cycle before receiving bills, the mobile phone in the prior art uses the technology in time calculation, therefore, when the total calling time is exceeded to a preset time, the phone will deliver a warning signal to warn the user that the time may be exceeded. However, it still cannot deliver the warning signal to users when the preset cumulated amount of money reached.

Therefore, the main purpose of this invention is to provide a kind of communication apparatus to solved the problem mentioned above.

### SUMMARY OF THE INVENTION

Accordingly, it is one object of the present invention to provide a mobile communication apparatus which is able to limit part of the dialing functions when the cumulated expense more a preset amount or several limit amounts based on real-time expense estimation. The limitations mentioned above is performed by shutting off part of the dialing functions of the communication module of the mobile communication apparatus, and the user and/or subscriber of the mobile communication apparatus are simultaneously notified with the over-use of the mobile communication apparatus, so the amount due is efficiently confined within a scope preset by user before the bill arrives.

The present invention relates to a wireless communication apparatus which performs mobile communication with SIM (Subscriber Identification Module), the mobile communication apparatus in the present invention at least includes a communication module, a storage module, a calculation module, a comparison module, and a limitation module.

The communication module is used to perform communications, i.e. registration, dialing, setting up a call, terminating a call, to other mobile communication apparatus. The preset amount is stored in the storage device, and the storage device may be set in the SIM card.

The calculation module, based on a CAI (Charge Advice Information) information fed to the calculation module, is used to real-time calculate cumulated expense resulted from usage in wireless communication of the mobile communication apparatus. The CAI is the information about the communication rates, deductibles, communication durations, communication categories, and communication areas of the mobile communication apparatus subscribed to a wireless carrier. The definition of the CAI information is pre-stored in the mobile communication apparatus or in the storage advice of the SIM card. Thus the calculation module can use it to estimate total cumulated expense. It would be better the CAI provided by the service provider directly.

The comparison module is used to compare the cumulated expense with the amount of preset amount stored in the storage module.

Through the result from the comparison module, when the cumulated expense is not less than the amount of the preset amount, the limitation module is activated to prevent over-use the mobile communication apparatus by shutting off part of the dialing functions of the communication module.

In addition, the limitation module at least includes an alert module and a termination module. When the cumulated expense reaches the preset amount, the alert module sends a warning message, mean while, the termination module prevent the communication module from communication by shutting off part of the dialing functions of the communication module.

Furthermore, the mobile communication apparatus at least includes a reset module and a timer. The timer provides a timing pulse, a reset instruction is transmitted to the reset module when the date on the timer matches a preset billing date, then the reset module is activated to reset the cumulated expense to its' initial value, such as zero, thus the cumulated expense can be count from its' initial value in the next billing cycle, the reset module also activates all the dialing functions for further using.

Substantially, due to the real-time estimation for the cumulated expense, the user may preset an amount of preset amounts, and the mobile communication apparatus in the present invention can automatically compare the preset amount and the cumulated expense even when the communication is proceeding. Accordingly, the limitation module may shut off part of the dialing functions of the communication module when the cumulated expense reaches the preset amount, and simultaneously notice the subscriber and/or user of the mobile communication apparatus of the overuse on the mobile communication apparatus, thus efficiently prevent the communication expense from exceeding user's budget.

### BRIEF DESCRIPTION OF THE DRAWINGS

The present invention will now be specified with reference to its preferred embodiment illustrated in the drawings, in which

FIG. 1 schematically illustrates the block diagram of a mobile communication apparatus in one preferred embodiment of the present invention;

FIG. 2 specifically illustrates the functional block diagram of the limitation module cooperated with other modules according to one preferred embodiment of the present invention;

FIG. 3 schematically illustrates the text of the warning message sent to notice the user of the mobile communication apparatus;

FIG. 4 schematically illustrates the other aspect of the alert message in the other preferred embodiment of the present invention;

FIG. 5 schematically illustrates the functional block diagram of a mobile communication apparatus, which can perform restriction communication that is preset by a procedure, according to another preferred embodiment of the present invention;

FIG. 6 schematically illustrates the functional block diagram of the mobile communication apparatus including a input module according to the other aspect of another preferred embodiment of the present invention; and

FIG. 7 schematically illustrates functional block diagram of a mobile communication apparatus including a reset module according to the other aspect of another preferred embodiment of the present invention.

### DESCRIPTION OF THE PREFERRED EMBODIMENT

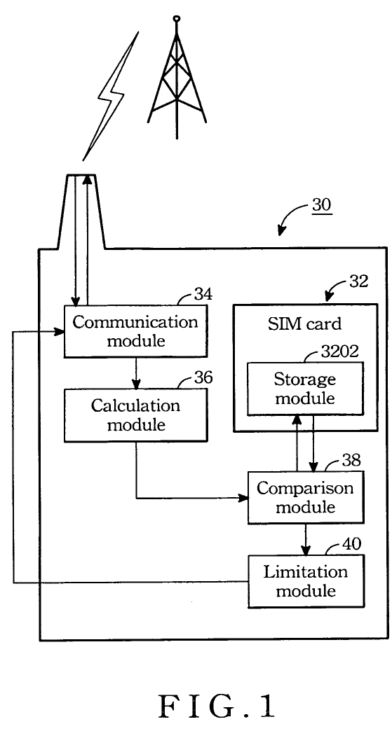

Please refer to FIG. 1 which schematically illustrates the block diagram of a mobile communication apparatus 30 in one preferred embodiment of the present invention, which illustrates that the foregoing apparatus utilizes a SIM (Subscriber Identity Module) card 32 to perform communication, wherein the SIM card 32 includes a storage module 3202, and the mobile communication apparatus 30 further includes a communication module 34, a calculation module 36, a comparison module 38, and a limitation module 40.

The communication module 34 enables the mobile communication apparatus 30 to communicate with outside communication apparatus, and the storage module 3202 is used to store a preset amount.

The calculation module 36 is used to counting the cumulated time duration that the mobile communication apparatus 30 performs communication. Because the calculation for wireless service fee is based on a fee-related data which includes the communication rates, deductibles, communication durations, communication categories, and communication areas. In addition, the fee-related data is contained in the charge advice information (CAI), so the calculation module 36 calculates the total expense of the mobile communication apparatus 30 according to the charge advice information (CAI). Wherein the communication categories mentioned above includes mobile-to-mobile service, communication between wireless carriers, and text message communication.

Specifically, the definition of the fee-related data can be preset and stored in the mobile communication apparatus 30 or in the storage module 3202 of the SIM card 32, thus fee-related data can be provided to the calculation module 36, accordingly, the total expense is acquired and can be shown to the consumer. In other words, the following parameter can be set in advance, such as the deductibles, i.e., monthly discount, can be set as $10.00 in advance, the communication rate can be set as one cent per minute, thirty percents off for night and/or weekend minutes, mobile-to-mobile free. Then the calculation module 36 can acquire these parameters from CAI to calculate the expense from the communication of corresponding mobile communication apparatus 30. If the user set up the parameters totally to the same as the carrier's definition, the foregoing result produced by the calculation module 36 will be coincident with the balance on the monthly statement from the wireless carrier, and the consumer can acquire the communication expanse before he receive the statement from wireless carrier.

The comparison module 38 is used to compare the communication expense from the calculation module 36 to the preset amount stored in the storage module 3202. In general, the foregoing preset amount is input by the consumer and is stored in the storage module 3202 as the preset amount mentioned above.

When the result from the comparison module 38 shows that the cumulated total expanse reaches the preset amount, the limitation module 40 will shut off part of the dialing functions of the communication function of the communication module 34 to prevent the total expanse from exceeding the preset amount. In detail, at the time when the total expanse reaches the preset amount, the communication module 34 will be shut off responding to the foregoing specific result from the comparison module 38.

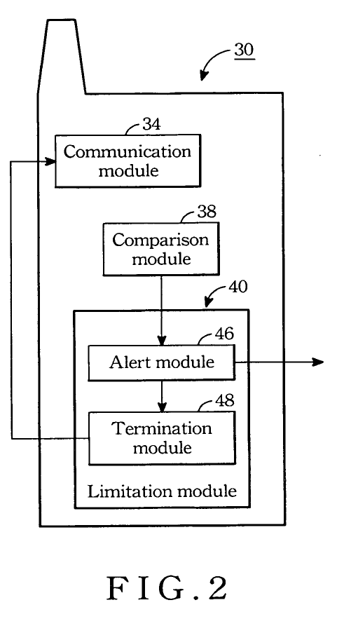

FIG. 2 specifically illustrates the functional block diagram of the limitation module 40 cooperated with other modules according to one preferred embodiment of the present invention. As depicted, the limitation module 40 of the mobile communication apparatus 30 includes an alert module 46 and a termination module 48. When the total expanse reaches the preset amount, the alert module 46 will send an alert message, and the communication module 34 will be shut off by the termination module 48.

The limitation module 40 according to one preferred embodiment of the present invention is described in the foregoing paragraph, then the other embodiment of the present invention of the limitation module 40 is described in the following paragraphs. The preset amount can be set as a first preset limit and a second preset limit. The second preset limit is higher than the first preset limit. In the other preferred embodiment of the present invention, the alert module 46 will send an alert message when the total expanse reaches the first preset limit. The communication module 34 still can be used normally or used with limited functions. Only when the total expanse reaches the second preset limit, the communication module 34 will be shut off part of the dialing functions by the termination module 48.

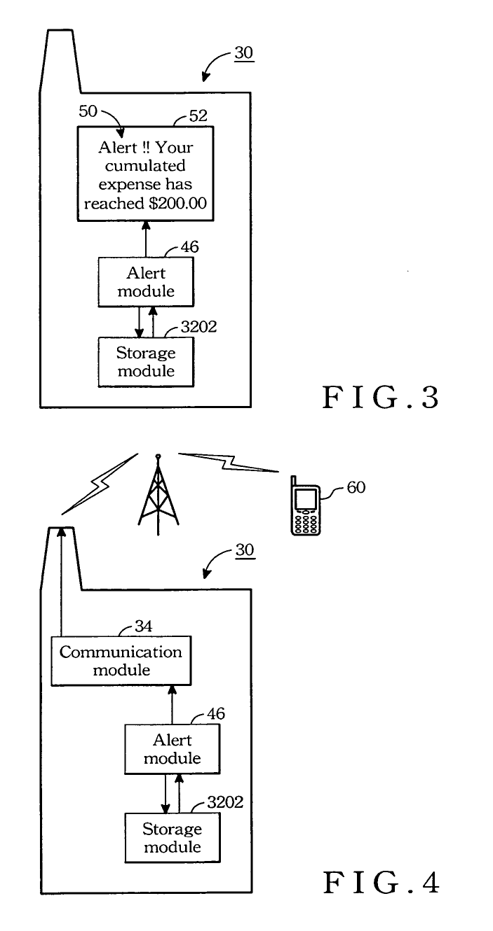

Please refer to FIG. 3, it schematically illustrates how and what the text of the warning message 50 will be sent to notice the user of the mobile communication apparatus 30. As shown in FIG. 3, the alert module 46 generates one of alert messages, e.g., warning message 50, stored in the storage module 3202, and show the text of the warning message 50 on the display panel 52 of the mobile communication apparatus 30. In detail, the text of the warning message 52 “Alert! Your cumulated expense has reached $200.00” can be replaced with a pattern which can catch the notice of the user of the fact that his expense has reached a preset amount.

FIG. 4 schematically illustrates how to practice the other aspect of the alert message in the other preferred embodiment of the present invention, as the mobile communication apparatus 30 in FIG. 4, in spite of the alert messages, a preset phone number is also stored in the storage module 3202. Through the communication module 34, the alert module 46 will automatically send the alert messages acquired from the storage module 3202 to communication device 60 with the preset phone number.

The hierarchy configuration mentioned above can be used in the following applications, such as the user of the mobile communication apparatus 30 is a child or a sale representative, and the subscriber of the mobile communication apparatus 30 is a guardian or employer that will pay for the bill for the mobile communication apparatus 30. In detail, the warning message will be sent to a remote communication device 60 responding to the preset phone number when the total expense spent by the user of the mobile communication apparatus 30 reaches the first preset limit. Thus, through the remote communication device 60, the bill payer will be informed of such an event, and timely and effectively prevent the mobile communication apparatus 30 from unexpected over-use.

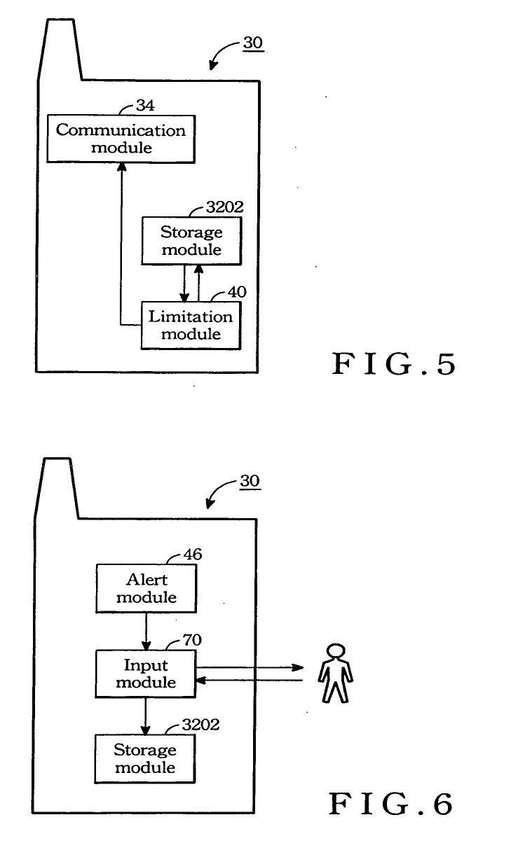

FIG. 5 schematically illustrates the functional block diagram of a mobile communication apparatus 30, which, according to another preferred embodiment of the present invention, can perform restriction dialing numbers that is preset by a specific procedure. In detail, the limitation module 40 can store at least one restriction phone number in the storage module 3204, and the limitation module 40 can restrict the communication between the mobile communication apparatus 30 and the communication apparatus, responding to the restriction phone number. According to the function of every kind of SIM card 32 nowadays, the restriction communication can be performed as described in the following examples.

The first example of the restriction communication is to block the communication between the mobile communication apparatus 30 and the communication apparatus with the restriction phone number. This kind of restriction communication is available by activating the BDN (Bar Dialed Number) function of current SIM card 32.

The second example of the restriction communication is to limit the mobile communication apparatus 30 may only communicate with the communication apparatus with the restriction phone number. This kind of restriction communication is available by activating the FDN (Fix Dialed Numbers) function of current SIM card 32.

In view of FIG. 5, please refer to FIG. 6, according to the other aspect of another preferred embodiment of the present invention, the mobile communication apparatus 30 further includes an input module 70. When the cumulated total expanse reaches the preset amount, the input module 70 will notice the user of the mobile communication apparatus 30 for determining that whether or not the number of the communication apparatus in communication is to be stored in the storage module 3204 as one of the restriction phone number. After the user of the mobile communication apparatus 30 have received a confirm message, i.e., the user of the mobile communication apparatus 30 confirm that the number, e.g., cell number, on line is allowed to stored in the storage module 3204 as one of the restriction phone numbers, then the input module 70 will store the number into the storage module 3204 as one of the restriction phone numbers. As described in the foregoing paragraph, the number can be stored as a FDN or a BDN restriction phone number.

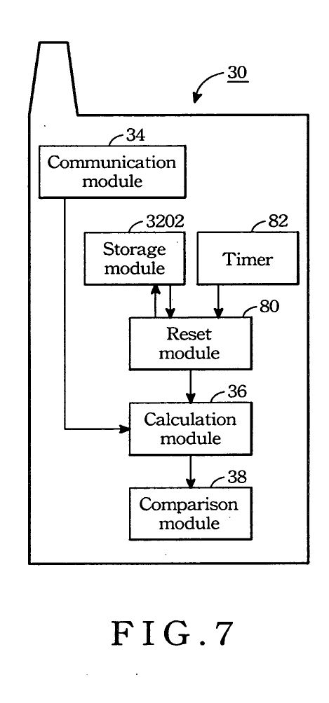

Please refer to FIG. 7, it schematically illustrates functional block diagram of a mobile communication apparatus 30 including a reset module 80, which responding to a reset instruction, resets the cumulated expense to the initial value, such as zero.

In addition, the mobile communication apparatus 30 includes a timer 82, which is used to provide time information. When the billing date stored in the storage module 3202 is due, according to the time information from the timer 82, the reset module 80 is activated by the reset instruction, for example monthly, and then the cumulated expense from the calculation module 36 returns to its' initial value, e.g., set expense to zero.

When the user is using the mobile communication apparatus 30, through the real-time comparison between the cumulated expense and the preset amount by the comparison module 38, the limitation module 40 can immediately shut off part of the dialing functions of the communication module 34. Meanwhile the alert module 46 will send a message showing that the total expense of the user of the mobile communication apparatus 30 exceeds a preset amount, thus further steps by the consumer can be used to effectively prevent the total expense from unexpected increase.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A mobile communication apparatus, comprising:
a communication module for performing wireless communication for said mobile communication apparatus;
a storage module for storing at least a preset amount;
a calculation module for calculating cumulated expense from wireless communication usage of said mobile communication apparatus;
a comparison module for comparing said cumulated expense with said preset amount; and
a limitation module for shutting off part of the dialing functions of said communication module, when said cumulated expense exceeding said preset amount.

2. The mobile communication apparatus as claim 1, said limitation module further comprising an alert module for generating an alert message when said cumulated expense reaching said preset amount.

3. The mobile communication apparatus as claim 2, said mobile communication apparatus further comprising a display panel, wherein said alert message illustrates on said display panel.

4. The mobile communication apparatus as claim 2, said storage module further storing a phone number, said communication module transmitting said alert message to another communication device according to said phone number.

5. The mobile communication apparatus as claim 2, said limitation module further comprising a termination module for shutting off part of the dialing functions of said communication module when said cumulated expense reaching said preset amount.

6. The mobile communication apparatus as claim 5, said preset amount comprising a first preset limit and a second preset limit, said second preset limit being higher than said first preset limit, said alert module sending said alert message when said cumulated expense reaching said first preset limit, said limitation module shutting off part of the dialing functions of said communication module when said cumulated expense reaching said second preset limit.

7. The mobile communication apparatus as claim 5, said storage module be further stored with a restriction phone number, said limitation module performing a restriction communication between said communication apparatus and a wireless communication device with said restriction phone number.

8. The mobile communication apparatus as claim 7, wherein said limitation module performing said restriction communication to prevent said communication apparatus from communicating with said wireless communication device with said restriction phone number.

9. The mobile communication apparatus as claim 7, wherein said limitation module performs said restriction communication to restrict said communication apparatus to communicate only with said wireless communication device with said restriction phone number.

10. The mobile communication apparatus as claim 7, said mobile communication apparatus further comprising an input module for determining inputting a number as said restriction phone number when said cumulated expense reaching said preset amount.

11. The mobile communication apparatus as claim 1, wherein said mobile communication apparatus is a mobile phone with a SIM (Subscriber Identity Module) card to perform wireless communication, and said storage module installed in said SIM card.

12. The mobile communication apparatus as claim 1, wherein said calculation module calculates said cumulated expense based on a CAI (Charge Advice Information) fed to said calculation module.

13. The mobile communication apparatus as claim 12, wherein said CAI is information of said mobile communication apparatus subscribed to a wireless carrier, which comprising communication rates, deductibles, communication durations, communication categories, and communication areas.

14. The mobile communication apparatus as claim 14, wherein said communication categories comprises mobile-to-mobile service, communication between carriers, and text message communication.

15. The mobile communication apparatus as claim 1, wherein said mobile communication apparatus further comprises a reset module resetting said cumulated expense to zero with a reset instruction.

16. The mobile communication apparatus as claim 15, wherein said mobile communication apparatus further comprises a timer for providing time information, said reset instruction being transmitted to said reset module when the date on said timer matching a preset billing date, said reset module being activated to reset said cumulated expense to zero.
